(19) United States
(12) Patent Application Publication
(10) Pub. No.: US 2017/0198658 A1
(43) Pub. Date: Jul. 13, 2017

(54) THRUST REVERSER

(71) Applicant: The Boeing Company, Chicago, IL (US)

(72) Inventor: Roger Higgins, Goose Creek, SC (US)

(21) Appl. No.: 14/993,036

(22) Filed: Jan. 11, 2016

(51) Int. Cl. F02K 1/60; F02K 1/62; F02K 1/76; B64D 33/04

(52) U.S. Cl. CPC F02K 1/60; B64D 33/04; F02K 1/62; F02K 1/76

(57) ABSTRACT

Systems and methods are provided for a thrust reverser. The thrust reverser may include one or more flapper doors. The flapper doors may be stored in a stored position within a housing portion of a nacelle of an aircraft propulsor. The flapper doors may then move to a deployed position (e.g., through rotation of the flapper doors or through other movements) when thrust reversing is desired. The aircraft propulsor may further include a thrust reverser door that covers an aperture within the nacelle. When the thrust reverser door is in an open position and the flapper doors are in the deployed position, airflow within the aircraft propulsor may be deflected by the flapper doors and out of the aircraft propulsor through the aperture.

### TECHNICAL FIELD

The disclosure relates generally to aircrafts and more specifically to aircraft thrust reversers.

### BACKGROUND

Various types of thrust reversers are utilized in aircraft propulsor nacelles. For example, some thrust reversers utilize various components that must physically slide along external surfaces of the nacelle. Other thrust reversers include components that project backward from the nacelle and expand in a parachute-like configuration. Unfortunately, such existing designs tend to be large and bulky. This complicates the storage, transport, and servicing of the nacelles and their related thrust reverser components.

### SUMMARY

Systems and methods are disclosed herein for a thrust reverser. In certain examples, an aircraft propulsor may be provided. The aircraft propulsor may include a nacelle including a thrust reverser aperture, a thrust reverser door configured to selectively move between an open position and a closed position to selectively block the thrust reverser aperture, a core engine circumscribed by the nacelle, and a plurality of flapper doors disposed circumferentially around the core engine. The nacelle and the core engine may define, at least in part, a bypass flow path. Each flapper door may be configured to move between a stored position out of the bypass flow path and a deployed position to at least partially block the bypass flow path, and divert at least a portion of airflow within the bypass flow path through the thrust reverser aperture when the flapper doors are in the deployed position and the thrust reverser door is in the open position.

In certain other examples, an aircraft may be provided. The aircraft may include a fuselage, a wing and an aircraft propulsor. The aircraft propulsor may include a nacelle including a thrust reverser aperture, a thrust reverser door configured to selectively move between an open position and a closed position to selectively block the thrust reverser aperture, a core engine circumscribed by the nacelle, where the nacelle and the core engine define, at least in part, a bypass flow path, and a plurality of flapper doors disposed circumferentially around the core engine where each flapper door may be configured to move between a stored position out of the bypass flow path and a deployed position to at least partially block the bypass flow path and divert at least a portion of airflow within the bypass flow path through the thrust reverser aperture when the flapper doors are in the deployed position and the thrust reverser door is in the open position. The aircraft may further include a controller communicatively connected to the aircraft propulsor and configured to provide instructions to move the plurality of flapper doors between the stored position and the deployed position and move the thrust reverser door between an open and a closed position.

In certain additional examples, a method may be provided. The method may include receiving airflow within a bypass flow path internal to an aircraft propulsor, moving a plurality of flapper doors from a stored position to a deployed position, wherein the plurality of flapper doors are disposed circumferentially around a core engine of an aircraft propulsor, moving a thrust reverser door from an open position to a closed position such that the thrust reverser door in the open position is configured to allow airflow through a thrust reverser aperture and the thrust reverser door in the closed position is configured to block airflow through the thrust reverser aperture, and diverting, with the plurality of the flapper doors in the deployed position, at least a portion of the airflow within the bypass flow path through the thrust reverser aperture.

The scope of the invention is defined by the claims, which are incorporated into this section by reference. A more complete understanding of the disclosure will be afforded to those skilled in the art, as well as a realization of additional advantages thereof, by a consideration of the following detailed description of one or more implementations. Reference will be made to the appended sheets of drawings that will first be described briefly.

### BRIEF DESCRIPTION OF THE DRAWINGS

FIG. 1 illustrates a perspective view of an aircraft propulsor in accordance with an example of the disclosure.

FIG. 2 illustrates a front cutaway view of an aircraft propulsor in accordance with an example of the disclosure.

FIG. 3A illustrates a perspective cutaway view of an aircraft propulsor with a flapper door thrust reverser system in a in a stored configuration in accordance with an example of the disclosure.

FIG. 3B illustrates another example cutaway of an aircraft propulsor with a flapper door thrust reverser system in a stored configuration in accordance with the disclosure.

FIGS. 4 and 5 illustrate a front cutaway view of an aircraft propulsor with a flapper door thrust reverser system in various stages of deployment in accordance with examples of the disclosure.

FIG. 6A and 6B illustrate flapper door actuators in accordance with examples of the disclosure.

FIG. 7 illustrates two flapper doors coupled by a flapper door link in accordance with the disclosure.

FIGS. 8A-B illustrate operation of a flapper door thrust reverser system in accordance with examples of the disclosure.

FIGS. 9A-C illustrate operation of an example of a thrust reverser door in accordance with examples of the disclosure.

FIG. 10 illustrates drag inducing flapper doors in accordance with examples of the disclosure.

Examples of the disclosure and their advantages are best understood by referring to the detailed description that follows. It should be appreciated that like reference numerals are used to identify like elements illustrated in one or more of the figures.

### DETAILED DESCRIPTION

Thrust reversers may be described in the disclosure herein. The thrust reverser may include flapper doors that may move between a stored, deployed, and, possibly, intermediate positions. The thrust reverser may also include one or more thrust reverser doors that may move between the open and closed position. The flapper doors and thrust reverser doors may move independently. When the flapper doors are in the deployed position and the thrust reverser doors are in the open position, airflow within the aircraft propulsor may be diverted to provide reverse thrust.

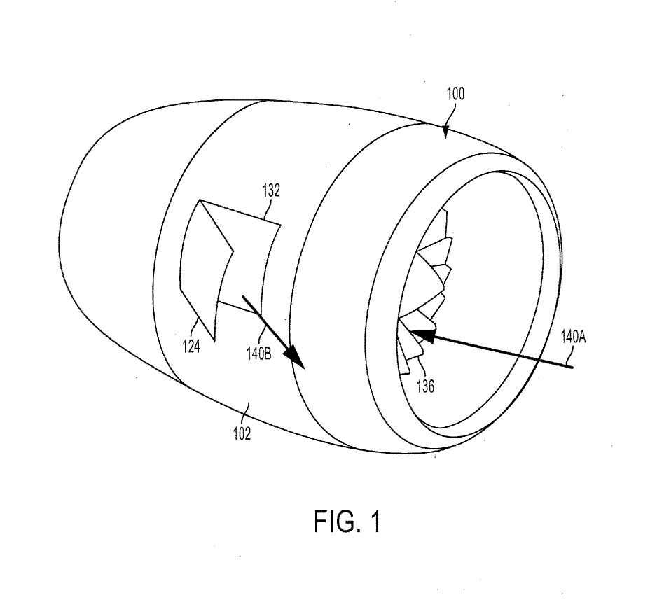

FIG. 1 illustrates a perspective view of an aircraft propulsor in accordance with an example of the disclosure. Aircraft propulsor 100 may include a nacelle 102, a thrust reverser aperture 132, a thrust reverser door 124, and a fan 136. In the example shown in FIG. 1, the nacelle 102 may contain the fan 136, but other examples of the aircraft propulsor may arrange the fan so that the fan is not contained by the nacelle (e.g., in, for example, a turboprop configuration). The fan 136 may intake and/or energize air flowing into the nacelle 102, such as in an airflow direction 140A. Air that flows into the nacelle 102 via airflow direction 140A may flow through various internal flowpaths within the nacelle 102.

When the aircraft propulsor 100 is normally operating (e.g., providing thrust), the thrust reverser door 124 may be in a closed position that blocks the thrust reverser aperture 132, sealing or substantially sealing the thrust reverser aperture 132 so that there is no or minimal airflow through the thrust reverser aperture 132. When the aircraft propulsor 100 is in a thrust reversing configuration (e.g., providing reverse thrust to, for example, slow an aircraft that the aircraft propulsor 100 is attached to), the thrust reverser door 124 may be in an open position that does not block the thrust reverser aperture 132, allowing for air to flow through the thrust reverser aperture 132. Such air flowing through the thrust reverser aperture 132 may flow in an airflow direction 140B. In some examples, at least a vector component of the airflow direction 140B may be in a direction opposite that of the airflow direction 140A (e.g., against the normal direction of airflow through the aircraft propulsor 100). As such, the air that flows in airflow direction 140B may provide negative thrust and thus may slow down an aircraft that the aircraft propulsor 100 is coupled to.

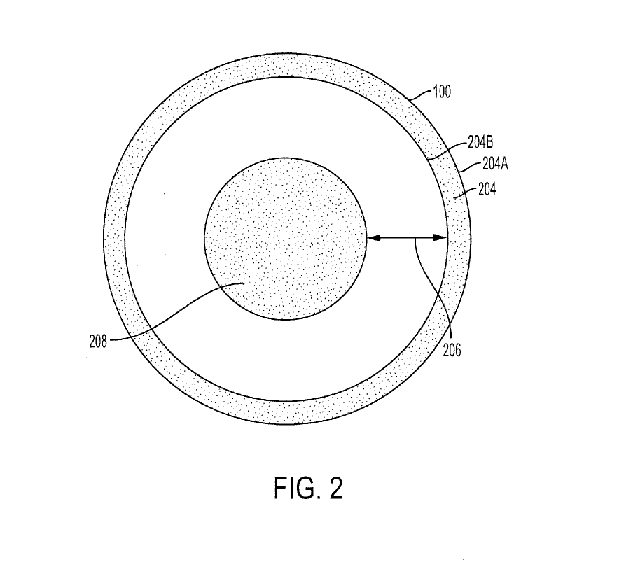

FIG. 2 illustrates a front cutaway view of an aircraft propulsor in accordance with an example of the disclosure. FIG. 2 may illustrate a cutaway for the aircraft propulsor 100 of FIG. 1 showing an example internal arrangement of the aircraft propulsor 100. In FIG. 2, the aircraft propulsor 100 may include a housing portion 204, a bypass flow path 206, and a core engine 208.

The housing portion 204 may be a portion of the nacelle where one or more thrust reverser flapper doors are maintained when in a stored position (e.g., a position where the flapper doors are not diverting airflow). In some examples, the housing portion 204 may comprise an outer structure 204A and an inner structure 204B. The outer structure 204A may, in certain examples, be a portion of the nacelle 102 of the aircraft propulsor 100, but in other examples, the outer structure 204A may be, for example, an outer bulkhead or other part of the aircraft propulsor 100 separate from the nacelle 102. The inner structure 204B may be, for example, an inner bulkhead or other part of the aircraft propulsor 100. The inner structure 204B may be any structure of the aircraft propulsor 100 that separates the housing portion 204 from the bypass flow path 206. In certain examples, the inner structure 204B may prevent at least a part of the air flowing within the bypass flow path 206 from entering at least a part of the housing portion 204, though other examples of the inner structure 204B may not prevent air from flowing from the bypass flow path 206 into the housing portion 204.

The flapper doors may be configured to move to a deployed position. In the deployed position, at least a portion of the flapper doors may be extended into the bypass flow path 206 to divert airflow within the bypass flow path 206 into the housing portion 204 and/or through the thrust reverser aperture 132. The bypass flow path 206 may be, for example, a flow path for bypass airflow of a turbofan aircraft propulsor (e.g., airflow that is not flowing through a core engine of the aircraft propulsor). A portion of the air intaked by the aircraft propulsor 100 may flow through the bypass flow path 206, such as after the air intake has been energized by the fan 136. In certain examples of the aircraft propulsor 100, such as examples where the propulsor is a high bypass turbofan engine, a larger percentage of air may be flowed through the bypass flow path 206 than through the core engine 208. In other examples, the flapper doors may divert airflow within other flow paths alternative to or in addition to airflow within the bypass flow path 206. For example, the flapper doors may divert airflow within the core engine 208 and/or within other flow paths of the aircraft propulsor 100.

In certain examples, the flapper doors may be hinged to rotate from the stored position to, at least, the deployed position and vice versa. Other examples may include additional positions for the flapper doors to rotate to, such as intermediate positions where the flapper doors may divert some, but not all airflow within the bypass flow path 206. In such intermediate positions, the flapper doors may divert a smaller percentage of the airflow within the bypass flow path 206 than in the deployed position.

The core engine 208 may, in certain examples, be an engine with a combustion chamber and other components. A portion of the air intaked by the aircraft propulsor 100 may flow through the core engine 208 to fuel combustion. Energy from the combustion within the core engine 208 may be used to power the fan 136 of the aircraft propulsor 100 to energize air that flows through the bypass flow path 206.

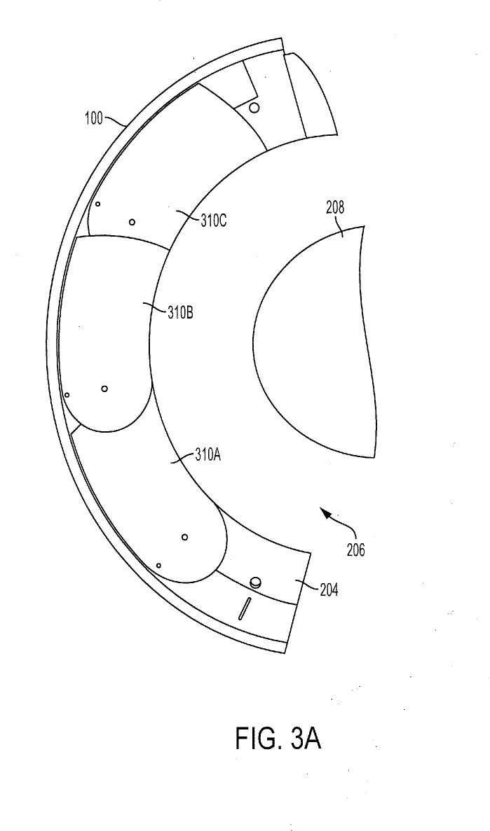

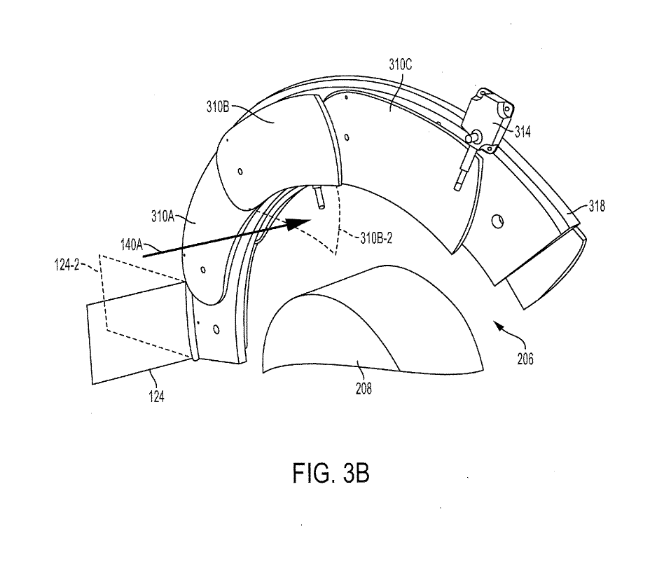

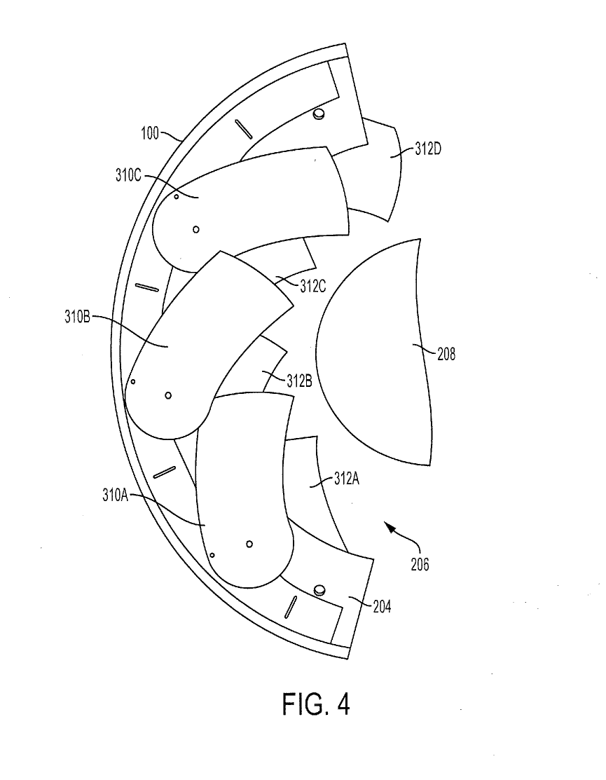

FIG. 3A illustrates a perspective cutaway view of an aircraft propulsor with a flapper door thrust reverser system in a in a stored configuration in accordance with an example of the disclosure. The aircraft propulsor 100 of FIG. 3A includes the housing portion 204, the bypass flow path 206, and the core engine 208. The housing portion 204 in FIG. 3A contains the flapper doors 310A-C.

The flapper doors 310A-C in FIG. 3A are shown in the stored position. In the stored position, the flapper doors 310A-C may be fully contained within the housing portion 204. In such a stored position, the flapper doors 310A-C may thus be positioned so as not to interfere with the,flow of air through the bypass flow path 206. In certain examples, a portion of the airflow within the bypass flow path 206 may flow into other portions of the aircraft propulsor 100, such as into the housing portion 204. For the purposes of this disclosure, any disruption of the flow of airflow through, for example, the housing portion 204 or other portions of the aircraft propulsor 100 that is not the bypass flow path 206 cannot be said to be interference of airflow within the bypass flow path 206.

FIG. 3B illustrates another example cutaway of an aircraft propulsor with a flapper door thrust reverser system in a stored configuration in accordance with the disclosure. In FIG. 3B, the flapper doors 310A-C are still in the stored position, where the flapper doors 310A-C do not interfere with airflow within the bypass flow path 206. However, flapper door position 310B-2 illustrates a possible deployed position or intermediate position (e.g., between the stored and deployed position) for the flapper door 310B. In the deployed position or in certain intermediate positions, the flapper door 310B may interfere with and/or divert at least a portion of the airflow flowing in, for example, the airflow direction 140A within the bypass flow path 206. In the example shown in FIG. 3B, at least a portion of the flapper door, when in the deployed or intermediate position, may intrude into the bypass flow path 206.

The flapper doors 310A-C may be moved between the stored and deployed positions via, at least partially, one or more actuators. For example, in FIG. 3B, the actuator 314 may move the flapper door 310C. The actuator 314 may telescope to move the actuator 314 between the stored and deployed positions. The actuator 314 may be hydraulically, electrically, and/or mechanically powered (e.g., may be powered hydraulically, electrically, and/or mechanically to telescope). In other examples, the actuator 314 move the flapper doors through other techniques, such as through springs (e.g., tension springs), cables, linkages, gears (e.g., bevel, worm, or other types of gears), chains, belts, and other techniques. In certain examples, the actuator 314 may move the flapper doors independently of any movement of the thrust reverser door 124.

The flapper doors 310A-C as well as the actuator 314 may be coupled to a nacelle structure 318. The nacelle structure 318 may be, for example, a frame or piece of a frame arranged circumferentially or partially circumferentially around the core engine 208 within the aircraft propulsor 100. The nacelle structure 318 may include points to mount the flapper doors 310A-C and/or actuator 314. In certain examples, the flapper doors 310A-C and/or actuators 314 may be coupled to other structures alternative to or in addition to the nacelle structure 318.

FIG. 3B further illustrates example positions of the thrust reverser door 124 as well as thrust reverser door open position 124-2. In normal operation of the aircraft propulsor 100, the thrust reverser door 124 may be in a closed position to block the thrust reverser aperture 132. The thrust reverser door 124 may, in the closed position, be at least the size of the thrust reverser aperture 132 so as to block all or the majority of the thrust reverser aperture 132. In certain examples, the thrust reverser door 124 may be larger than the thrust reverser aperture 132.

The thrust reverser door open position 124-2 may be an example position that the thrust reverser door 124 may move to in order to allow airflow through the thrust reverser aperture 132. In certain examples, when at least one of the flapper doors 310A-C is in the deployed or intermediate position and the thrust reverser door 124 is in the thrust reverser door open position 124-2, airflow that may flow in, for example, the airflow direction 140A within the bypass flow path 206 may be diverted by the flapper doors 310A-C in the deployed or intermediate position and through the thrust reverser aperture 132 to provide reverse thrust to slow an aircraft that the aircraft propulsor 100 is attached to.

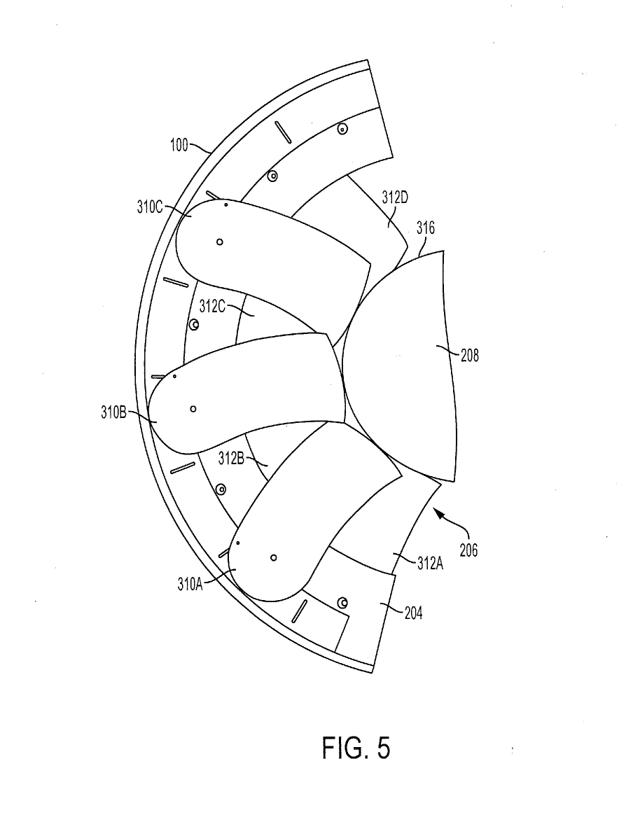

The flapper doors 310A-C may be configured to rotate into a deployed position so as to divert at least a portion of the airflow within the bypass flow path 206. FIGS. 4 and 5 illustrate a front cutaway view of an aircraft propulsor with a flapper door thrust reverser system in various stages of deployment in accordance with examples of the disclosure. FIG. 4 may illustrate the flapper doors 310A-C, as well as flapper doors 312A-D, in an intermediate position while FIG. 5 may illustrate the flapper doors 310A-C and 312A-D in a deployed position.

The flapper doors 310A-C and/or 312A-D illustrated in

FIGS. 4 and 5 may be hinged to a part of the structure of the aircraft propulsor 100 (e.g., the nacelle 102) and may rotate between the stored, deployed, and intermediate positions. The axis of rotation of the flapper doors 310A-C and/or 312A-D may be collinear, parallel, or substantially collinear or parallel (e.g., approximately +/−30 degrees) with the direction of airflow within the bypass flow path 206. Other examples of the flapper doors 310A-C and/or 312A-D may rotate around an axis that is not collinear or substantially collinear with the direction of airflow within the bypass flow path 206.

In certain other examples, the flapper doors 310A-C and/or 312A-D may, alternatively or in addition to rotating between the various positions, also move between the stored, deployed, and intermediate positions by other motions such as translating, twisting, compressing, expanding (e.g., through a bellow-like motion), or other motions that may result in changes to the area covered by the flapper doors 310A-C and/or 312A-D.

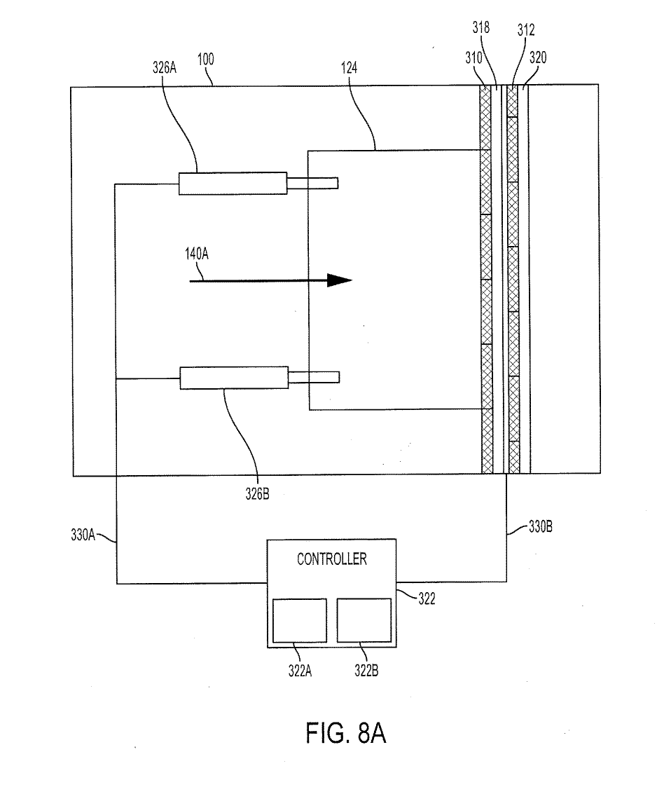

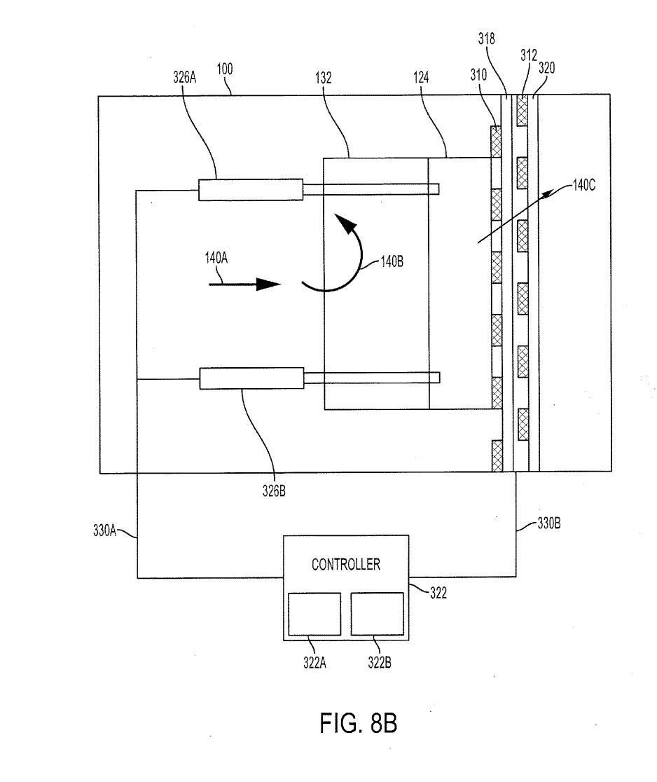

The flapper doors 312A-D may be an additional set of flapper doors within the aircraft propulsor 100. In certain examples, the flapper doors 310A-C may not divert a desired amount of airflow within the bypass flow path 206. For example, the flapper doors 310A-C may not fully cover a cross section of the bypass flow path 206 and thus the airflow or a portion of the airflow within the bypass flow path 206 may, instead of being diverted through the thrust reverser aperture 132, flow around the flapper doors 310A-C. In certain situations, additional thrust reversing may be desired. As such, another set of flapper doors in addition to the flapper doors 310A-C, such as flapper doors 312A-D, may be used to divert additional airflow within the bypass flow path 206. The flapper doors 312A-D may, separately or in combination with the flapper doors 310A-C, cover a larger cross sectional area of the bypass flow path 206 and thus increase the thrust reversing capabilities of the aircraft propulsor 100. In certain examples, the flapper doors 312A-D may be mounted on a cross sectional plane of the aircraft propulsor 100 different from the plane that the flapper doors 310A-C are mounted on (e.g., in an overlapping manner). Such mounting may be further illustrated in FIGS. 8A and 8B.

In FIG. 5, the flapper doors 310A-C and 312A-D are in a deployed position. As seen in FIG. 5, due to the overlapping manner of flapper doors 310A-C and 312A-D, the section of the bypass flow path 206 covered by the flapper doors 310A-C and 312A-D may be fully or almost fully blocked when the flapper doors 310A-C and/or 312A-D are in the deployed position.

In some examples, the flapper doors 310A-C and/or 312A-D in the deployed position may rest next to or against the core engine 208. In certain examples, the flapper doors 310A-C and/or 312A-D and/or core engine 208 may include a retainer feature or multiple retainers that are designed to more securely hold the flapper doors 310A-C and/or 312A-D to, for example, a portion of the core engine 208 when the flapper doors 310A-C and/or 312A-D are in the deployed position. Such retainer features may include, for example, retainer feature 316 on the core engine 208, that may be a gasket, a detent, a magnet, a bearing, or another feature that may more securely hold the flapper doors 310A-C and/or 312A-D against the core engine 208.

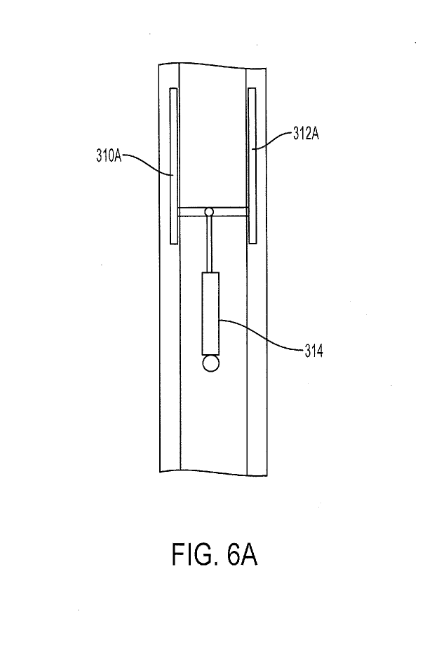

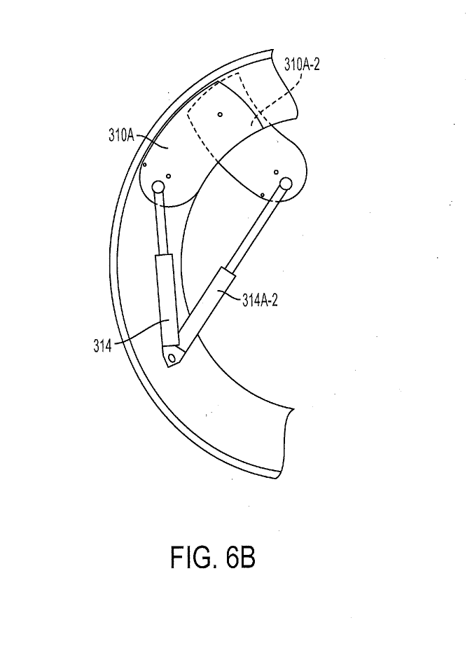

FIG. 6A and 6B illustrate flapper door actuators in accordance with examples of the disclosure. FIGS. 6A and 6B may illustrate in further detail, flapper doors 310A and 312A and the actuator 314. In FIGS. 6A and 6B, the actuator 314 may be coupled to both the flapper doors 310A and 312A. Thus, the actuator 314 may concurrently move both the flapper doors 310A and 312A between stored and deployed positions.

Such positions may be further illustrated in FIG. 6B. In FIG. 6B, the flapper door 310A may be in a stored position and the actuator 314 may be accordingly retracted. In the flapper door position 310A-2, the flapper door 310A may be in a deployed position and the actuator may be in an extended position 314-2. In addition, the flapper door 312A may also be in a deployed position.

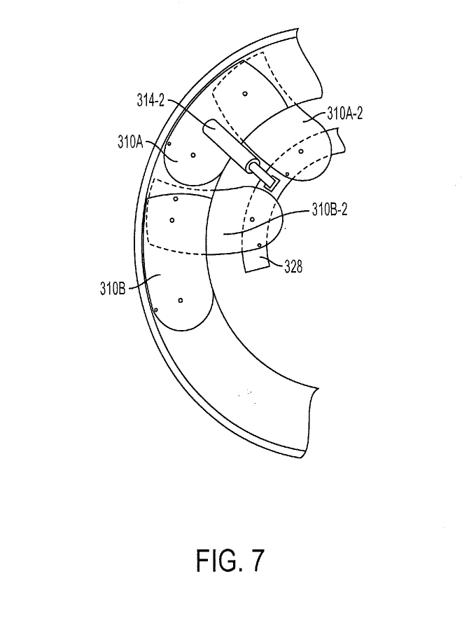

FIG. 7 illustrates two flapper doors coupled by a flapper door link in accordance with the disclosure. In FIG. 7, the flapper doors 310A and 310B may be connected by the flapper door link 328. The flapper door link 328 may transfer movement between the two flapper doors 310A and 310B. Accordingly, the movement of one of the flapper doors 310A and 310B may result in movement of the other of the flapper doors 310A and 310B.

In FIG. 7, the actuator 314 may be connected to the flapper door link 328. Though the flapper door link 328 in FIG. 7 may be of a semi-circular shape, other examples of the flapper door link 328 may be in other shapes. Movement of the actuator 314 (e.g., extension of telescoping portions of the actuator 314 to push the flapper door link 328 from a position closer to an outer portion of the nacelle 102 to a position farther from the outer portion of the nacelle 102) maybe transferred to the flapper door link 328 and then to the flapper doors 310A and 310B to move them from a stored position to the flapper door positions 310A-2 and 310B-2, which may be intermediate or deployed positions. Other examples of the aircraft propulsor 100 may connect the actuator 314 to one or more of the flapper doors 310A and 310B. In such examples, the flapper door link 328 may then transfer movement between the flapper doors 310A and 310B.

FIGS. 8A-B illustrate operation of a flapper door thrust reverser system in accordance with the disclosure. The aircraft propulsor 100 in FIGS. 8A-B may include the thrust reverser aperture 132, the thrust reverser door 124, a first set of flapper doors 310 connected by a first flapper door link and mounted to a first nacelle structure 318, a second set of flapper doors 312 connected by a second flapper door link and mounted to a second nacelle structure 320, thrust reverser door actuators 326A and 326B, and a controller 322.

The first and second set of flapper doors 310 and 312 may be similar to the flapper doors described herein. However, in the example in FIG. 8A, the first and second set of flapper doors 310 and 312 may be coupled to the first and second flapper door links.

The flapper door links may link movement of the sets of flapper doors 310 and 312, respectively. As such, the number of actuators moving the flapper doors 310 and/or 312 may be less than the number of individual flapper doors 310 and/or 312 and may be as low as one actuator per set of connected flapper doors 310 and/or 312 (though other examples may include multiple actuators per set of flapper doors 310 and/or 312 or may include a number of actuators equal to or even greater than the amount of flapper doors 310 and/or 312). The first and second set of flapper doors 310 and 312 may be arranged circumferentially around, for example, the core engine 208 of the aircraft propulsor 100.

The thrust reverser door 124 may, when in the closed position, block airflow through the thrust reverser aperture 132. The thrust reverser door 124 in the open position may allow airflow through the thrust reverser aperture 132. The thrust reverser door actuators 326A and 326B may move the thrust reverser door 124. Though the example shown in FIG. 8A includes two actuators to move the thrust reverser door 124, other examples may include only one actuator or may include three or more actuators to move the thrust reverser door 124. The thrust reverser door actuators 326A and 326B may be a telescoping or other style actuator, as described herein. Movement of the thrust reverser door 124 (via the thrust reverser door actuators 326A and 326B) and/or the first and/or second set of flapper doors 310 and 312 (via the associated actuators) may be controlled by the controller 322. For example, the controller 322 may be communicatively connected to the thrust reverser door actuators 326A and 326B via the communications link 330A and may be communicatively connected to the first and/or second set of flapper doors 310 and 312, or their associated actuators, via the communications link 330B.

The controller 322 may include, for example, a processor 322A (e.g., a single-core or multi-core processor or microprocessor, a microcontroller, a logic device, a signal processing device and/or others), a memory 322B for storing data and executable instructions (e.g., software, firmware, or other instructions to be executed by processor 322A), and/or other components as appropriate to perform any of the various operations described herein. In various examples, memory 322B may be implemented by volatile and/or non-volatile memory. Examples of such memories include RAM (Random Access Memory), ROM (Read-Only Memory), EEPROM (Electrically-Erasable Read-Only Memory), flash memory, or other types of memory. In various examples, the controller 322 and/or its associated operations may be implemented as a single device or multiple devices (e.g., communicatively linked through wired or wireless connections) to collectively constitute the controller 322.

The controller 322 may be communicatively coupled to, for example, the thrust reverser door actuators 326A and 326B and/or the flappers doors 310 and 312 or the actuators coupled to the flapper doors 310 and 312, as well as possibly other systems. The controller 322 may provide instructions to control the movement and/or actuation of the components described herein.

In certain examples, the instructions to control the movement and/or actuation of the thrust reverser door 124 and the flapper doors 310 and/or 312 may be provided independently. That is, the controller 322 may move the thrust reverser door 124 while the first and/or second set of flapper doors 310 and/or 312 are stationary, and vice versa. As such, unlike in conventional systems, the thrust reverser door 124 and the flapper doors do not need to be coupled. Uncoupled thrust reverser door 124 and flapper doors 310 and/or 312 allow for easier service as the thrust reverser door 124 and flapper doors 310 and/or 312 may be removed independently of each other (e.g., removal of one system does not necessitate the removal of the other system). Accordingly, each system may be smaller and thus removal and transport of the individual systems may be easier and aircraft service may be likewise improved. Also, as the thrust reverser door 124 and the flapper doors 310 and/or 312 are not coupled, a mechanical linkage between the systems is not necessary and so the size of the aircraft propulsor 100 and/or the size of the nacelle 102 may be decreased. The decreased size may lead to an increase in aircraft efficiency (due to, for example, decreased drag) and accordingly provide improved acceleration, speed, and/or fuel efficiency.

In FIG. 8A, the aircraft propulsor 100 may be in a normal operation mode. Accordingly, the flapper doors 310 and/or 312 may thus be in a stored position and the thrust reverser door 124 may be in a closed position. Air, energized by the fan 136, may flow through the bypass flow path 206 within the aircraft propulsor 100 in the airflow direction 140A. The air may be energized by the fan 136 and flow through the bypass flow path 206 and out through an exhaust and/or nozzle when the aircraft propulsor 100 is operating in the normal mode.

In FIG. 8B, the aircraft propulsor 100 may be in a thrust reversing mode. In the thrust reversing mode, the controller 322 may have provided commands to move the first and second set of flapper doors 310 and 312 into the deployed position by, for example, providing commands to the actuators coupled to the first and second set of flapper doors 310 and 312 to move the flapper doors 310 and 312 into the deployed position. The first set of flapper doors 310 may be mounted and rotated on a plane different from that of the plane that the second set of flapper doors 312 is mounted and rotated on.

Additionally, in the thrust reversing mode, the thrust reverser door 124 may be translated and/or rotated (e.g., where at least a portion of the thrust reverser door 124 may be rotated outward away from the nacelle 102) to uncover at least a part of the thrust reverser aperture 132 and allow air to flow through the thrust reverser aperture 132. In certain examples, air that is redirected by the flapper doors 310 and 312 may be diverted to airflow direction 140B to flow through the thrust reverser aperture 132 to provide reverse thrust.

In certain examples, the first and/or second set of flapper doors 310 and 312 may not, in the plane that they move and/or rotate in, cover the entire cross sectional area of the bypass flow path 206. Accordingly, even though there may be multiple sets of flapper doors 310 and 312, there may still be open areas where air may flow between the flapper doors 310 and 312, as illustrated by airflow path 140C. The airflow path 140C may be a flow path of air that flows between the flapper doors of the first and second set of flapper doors 310 and 312 (and out of the exhaust and/or nozzle of the aircraft propulsor 100). Though airflow that flow past the flapper doors may not be redirected to provide reverse thrust, in certain examples, as long as a sufficient amount of airflow is redirected, enough reverse thrust may be provided to slow the aircraft.

Additionally, in certain examples, the flapper doors 310 and/or 312 may be in an intermediate position and the thrust reverser door 124 may be in an intermediate or open position such that the aircraft propulsor 100 generates minimal thrust or reverse thrust (e.g., not enough thrust or reverse thrust to move the aircraft forward or backward). In such an example, closing the thrust reverser door 124 and moving the flapper doors 310 and 312 to a stored position may then suddenly provide thrust to accelerate the aircraft.

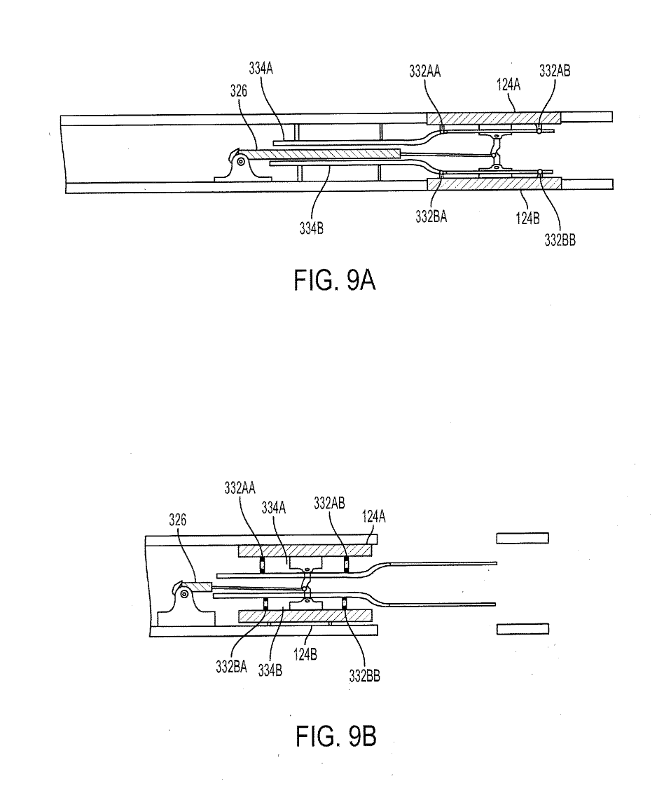

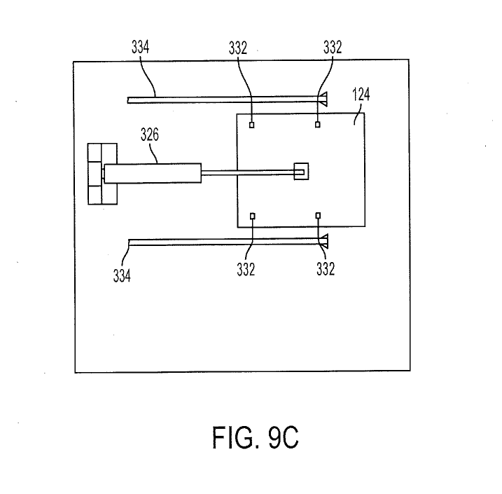

FIGS. 9A-C illustrate operation of an example of a thrust reverser door in accordance with examples of the disclosure. FIGS. 9A and 9B may include an inner thrust reverser door 124A, an outer thrust reverser door 124B, guiderails 334A and 334B, a thrust reverser door actuator 326, and bearings 332AA, 332AB, 332BA, and 332BB.

The outer thrust reverser door 124A may, in a closed position, seal an outer thrust reverser aperture. The outer thrust reverser aperture may be an aperture within an outer layer of the nacelle 102. The outer thrust reverser aperture may, when the outer thrust reverser door 124A is in an open position, allow air to flow outward to an ambient environment. In certain examples, the outer thrust reverser door 124A may, when in the open position, be disposed of proximate to an outer wall of the nacelle of the aircraft propulsor 100.

The inner thrust reverser door 124B may, in a closed position, seal an inner thrust reverser aperture. The inner thrust reverser aperture may be an aperture within an inner layer of the nacelle 102. The inner thrust reverser aperture may be an aperture within a structure separating the bypass flow path 206 from the housing portion 204 of the nacelle 102. In certain examples, when the inner thrust reverser door 124B is in the closed position, the inner thrust reverser aperture may be sealed and thus the airflow path through the inner thrust reverser aperture between the bypass flow path 206 and the housing portion 204 may be blocked. When the inner thrust reverser door 124B is in the open position, air (that may be diverted by the flapper doors 310 and/or 312) may flow between the bypass flow path 206 and the housing portion 204. In certain examples, the inner thrust reverser door 124B may, when in the open position, be disposed of proximate to an inner wall of the nacelle of the aircraft propulsor 100. In such examples, both the outer thrust reverser door 124A and the inner thrust reverser door 124B may, when in the open positions, be housed internally (e.g., away or substantially away from airflow).

In FIG. 9A and 9B, the outer and inner thrust reverser doors 124A and 124B may be coupled. That is, the actuator 326 may move both the outer and inner thrust reverser door 124A and 124B between the open and closed positions, as well as any positions in between the open and closed positions. In FIG. 9A, the outer and inner thrust reverser doors 124A and 124B may be in the closed position while in FIG. 9B, the outer and inner thrust reverser doors 124A and 124B may be in the open position.

The outer and inner thrust reverser doors 124A and 124B may be mounted, via the bearings 334AA-AB and 334BA-BB, respectively, to the guiderails 334A and 334B. Accordingly, the outer and inner thrust reverser doors 124A and 124B may translate or at least partially translate along the guiderails 334A and 334B between the open and closed positions. The guiderails 334A and 334B may be formed so that, in the closed positions, at least a portion of the thrust reverser doors are flush with a portion of the nacelle 102 (e.g., the outer thrust reverser door 124A may be flush with the outer portion of the nacelle 102 so that air may smoothly flow over the surface of the nacelle 102), but in the closed positions, the thrust reverser doors 124A and 124B may be drawn into a volume within the housing portion 204 and/or another volume within the nacelle 102.

FIG. 9C may be a side view of FIG. 9A. In FIG. 9C, the thrust reverser door 124 may be in the closed position. As shown in FIG. 9C, the guiderails 334 may be set off to the side of the thrust reverser aperture. That is, the guiderails 334 may be positioned so that they do not impeded airflow through the thrust reverser aperture.

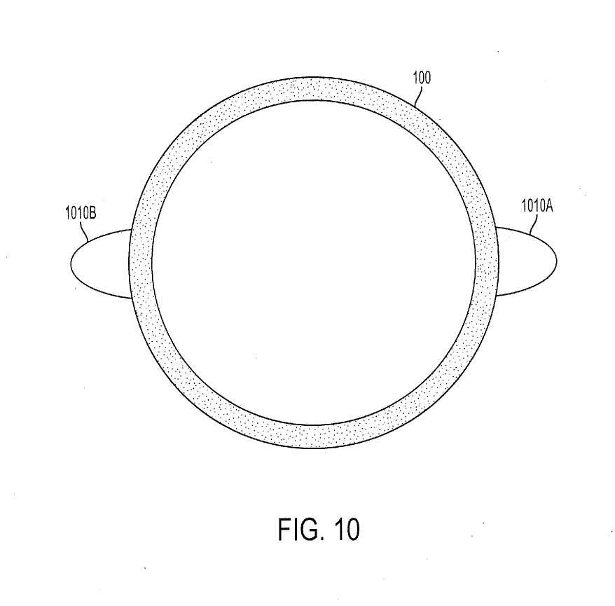

FIG. 10 illustrates drag inducing flapper doors in accordance with examples of the disclosure. FIG. 10 may be another example of the flapper doors. In FIG. 10, at least a portion of the flapper doors of the aircraft propulsor 100 may be configured to move to a blocking position. At least a portion of the flapper doors 1010A and/or 1010B in the blocking position may be disposed outside of the nacelle 102 of the aircraft propulsor 100. As such, the flapper doors 1010A and 1010B in the blocking position increase drag of the aircraft when in the blocking position and may aid in the deceleration of the aircraft. In certain examples, the nacelle 102 of the aircraft propulsor 100 where at least a portion of the flapper doors 1010A and/or 1010B may be configured to move to the blocking position may include slots, doors, gaskets, and other devices and mechanisms that may allow for the flapper doors 1010A and/or 1010B to be disposed of outside of the nacelle 102 when the flapper doors 1010A and/or 1010B are in the blocking position, but to seal and/or create a smooth surface on the outside of the nacelle 102 when the flapper doors 1010A and/or 1010B are not in the blocking position. As such, normal operation of the aircraft propulsor 100 may not be impacted when the flapper doors 1010A and/or 1010B are not in the blocking position.

Examples described above illustrate but do not limit the invention. It should also be understood that numerous modifications and variations are possible in accordance with the principles of the present invention. Accordingly, the scope of the invention is defined only by the following claims.

What is claimed is:

1. An aircraft propulsor comprising:
a nacelle comprising a thrust reverser aperture;
a thrust reverser door configured to selectively move between an open position and a closed position to selectively block the thrust reverser aperture;
a core engine circumscribed by the nacelle, wherein the nacelle and the core engine define, at least in part, a bypass flow path; and
a plurality of flapper doors disposed circumferentially around the core engine, each flapper door configured to:
move between a stored position out of the bypass flow path and a deployed position to at least partially block the bypass flow path, and
divert at least a portion of airflow within the bypass flow path through the thrust reverser aperture when the flapper doors are in the deployed position and the thrust reverser door is in the open position.

2. The aircraft propulsor of claim 1, wherein the plurality of flapper doors are stored in a housing portion of the nacelle when in the stored position.

3. The aircraft propulsor of claim 1, wherein the thrust reverser door is configured to move between the open position and the closed position independent of the flapper doors moving between the stored positions and the deployed positions.

4. The aircraft propulsor of claim 1, wherein the plurality of flapper doors are configured to rotate between the stored position and the deployed position around an axis substantially parallel and/or collinear with a direction of the airflow.

5. The aircraft propulsor of claim 1, further comprising a flapper actuator, coupled to the nacelle and at least one of the flapper doors, wherein the actuator is configured to rotate the at least one flapper door between the stored position and the deployed position.

6. The aircraft propulsor of claim 1, further comprising a flapper door link coupled to at least two of the flapper doors and configured to connect the at least two flapper doors such that motion is transmitted between the at least two flapper doors.

7. The aircraft propulsor of claim 1, wherein the thrust reverser door comprises a door panel coupled to the nacelle and a thrust reverser actuator coupled to the nacelle and the door panel, wherein the thrust reverser actuator is configured to move the thrust reverser door between the open and the closed positions.

8. The aircraft propulsor of claim 1, wherein the plurality of flapper doors are coupled to the nacelle and the thrust reverser door is coupled to the nacelle.

9. The aircraft propulsor of claim 1, wherein each of the plurality of flapper doors and/or the core engine comprise a retainer configured to hold the flapper door to the core engine when the flapper door is in the deployed position.

10. The aircraft propulsor of claim 1, wherein the plurality of flapper doors comprise at least a first flapper door and a second flapper door, the first flapper door is configured to block a first area of the bypass flow path when in the deployed position, and the second flapper door is configured to block a second area of the bypass flow path when in the deployed position.

11. The aircraft propulsor of claim 10, wherein the plurality of flapper doors are configured to divert a majority of the airflow within the bypass flow path when in the deployed position.

12. The aircraft propulsor of claim 1, wherein at least one of the plurality of flapper doors is further configured to move to a blocking position and wherein at least a portion of the flapper door is disposed outside of the nacelle when the flapper door is in the blocking position.

13. The aircraft propulsor of claim 1, wherein the plurality of flapper doors are configured to be removed from the aircraft propulsor independent of the thrust reverser door.

14. An aircraft comprising:
a fuselage;
a wing;
an aircraft propulsor comprising:
a nacelle comprising a thrust reverser aperture,
a thrust reverser door configured to selectively move between an open position and a closed position to selectively block the thrust reverser aperture,
a core engine circumscribed by the nacelle, wherein the nacelle and the core engine define, at least in part, a bypass flow path, and
a plurality of flapper doors disposed circumferentially around the core engine, each flapper door configured to:
move between a stored position out of the bypass flow path and a deployed position to at least partially block the bypass flow path; and
divert at least a portion of airflow within the bypass flow path through the thrust reverser aperture when the flapper doors are in the deployed position and the thrust reverser door is in the open position; and
a controller communicatively connected to the aircraft propulsor and configured to provide instructions to move the plurality of flapper doors between the stored position and the deployed position and move the thrust reverser door between an open and a closed position.

15. The aircraft of claim 14, wherein the controller is configured to provide instructions to move the flapper door to the deployed position and move the thrust reverser door to the open position to divert the portion of airflow within the bypass flow path through the thrust reverser aperture to provide thrust to slow the aircraft.

16. The aircraft of claim 14, wherein the aircraft propulsor further comprises a flapper door link coupled to at least two of the flapper doors and configured to connect the at least two flapper doors such that motion is transmitted between the at least two flapper doors.

17. The aircraft of claim 14, wherein the plurality of flapper doors are configured to be removed from the aircraft propulsor independent of the thrust reverser door.

18. A method comprising:
receiving airflow within a bypass flow path internal to an aircraft propulsor;
moving a plurality of flapper doors from a stored position to a deployed position, wherein the plurality of flapper doors are disposed circumferentially around a core engine of an aircraft propulsor;
moving a thrust reverser door from an open position to a closed position, wherein the thrust reverser door in the open position is configured to allow airflow through a thrust reverser aperture and the thrust reverser door in the closed position is configured to block airflow through the thrust reverser aperture; and
diverting, with the plurality of the flapper doors in the deployed position, at least a portion of the airflow within the bypass flow path through the thrust reverser aperture.

19. The method of claim 18, wherein the airflow is diverted to provide thrust to slow an aircraft.

20. The method of claim 18, wherein the moving the flapper doors is performed independent of the moving the thrust reverser door.
